(19) United States
(12) Patent Application Publication
(10) Pub. No.: US 2011/0281057 A1
(43) Pub. Date: Nov. 17, 2011

(54) BULKED CONTINUOUS FILAMENTS WITH HEXALOBAL CROSS-SECTION AND THREE VOIDS AND SPINNERET PLATES FOR PRODUCING THE FILAMENT

(75) Inventor: Wae-Hai Tung, Marietta, GA (US)

(73) Assignee: INVISTA North America S.ar.l., Wilmington, DE (US)

(21) Appl. No.: 13/060,163

(22) PCT Filed: Aug. 14, 2009
(86) PCT No.: PCT/US09/53868

§ 371 Date: Mar. 25, 2011

Related U.S. Application Data
(60) Provisional application No. 61/090,929, filed on Aug. 22, 2008.

(51) Int. Cl. D02G 3/22; B32B 5/02; D01D 5/24; B32B 3/00

(52) U.S. Cl. 428/85; 428/398; 425/470; 264/209.1

(57) ABSTRACT

Briefly described, embodiments of this disclosure include hexalobal bulked continuous filaments with three axial voids, spinneret plates with a capillary design for producing the hexalobal, tri-void bulked continuous filaments (BCFs) of the present disclosure, articles made from the hexalobal filaments of the present disclosure, methods of making the hexalobal, tri-void filaments of the present disclosure, and the like.

### CROSS-REFERENCE TO RELATED APPLICATION

This application claims benefit of priority from U.S. Provisional Application No. 61/090929 filed Aug. 22, 2008.

### BACKGROUND

Bulked continuous filaments (BCFs) of different cross-sections may be formed to impart different qualities to the filaments/fibers and articles produced with the fibers, such as carpet yarn and carpets. The particular cross-sectional geometry of synthetic fibers is known to affect various physical properties of the fiber and articles formed from such fibers. The cross-sectional geometry of BCF affects both the performance as well as the look and feel of articles, such as carpet, formed from the fibers. For example, the cross-sectional shape of the fiber is known to affect both soiling, durability as well as the “glitter” or “luster” (e.g., the light-reflecting ability) of carpet yarn formed from the fibers.

While carpet yams having relatively high levels of “glitter” are useful for certain applications, there nevertheless remains a substantial demand for yarns that provide a lower glitter, more wool-like appearance and that also provide superior soil hiding abilities. Some known trilobal filaments with single voids provide decent soiling resistance and durability, but have high glitter. Some voidless or solid trilobal filaments of exhibit low glitter, but are not as effective at soil resistance. Additionally, some filament designs have cross-sectional geometries that require an intricate capillary design such that the spinneret plate is less durable and more difficult to spin at effective rates.

Thus, there is a need in the industry for a bulked continuous filament for use as carpet yarn that exhibits an aesthetically appealing low glitter but has excellent soiling resistance. There is also a need in the industry for a spinneret that produces a fiber or filament with the above-mentioned qualities and that is also durable and easy to spin at effective spin rates.

### SUMMARY

Embodiments of the present disclosure include hexalobal bulked continuous filaments with three axial voids, spinneret plates with a capillary design for producing the hexalobal, tri-void bulked continuous filaments (BCFs) of the present disclosure, articles made from the hexalobal filaments of the present disclosure, methods of making the hexalobal, tri-void filaments of the present disclosure, and the like.

One exemplary bulked continuous filament of the present disclosure, among others, is a BCF made from at least one synthetic polymer and includes a hexalobal cross-sectional geometry with three major lobes and three minor lobes, with each minor lobe located between each of two major lobes. The filament also has three voids extending axially through the filament, the approximate center of each void radially aligned with the approximate center of a corresponding major lobe.

Another exemplary BCF of the present disclosure, among others, is formed from at least one synthetic polymer and includes a hexalobal cross section and an exterior configuration having six sides and six apexes, each apex located at a meeting point between two adjoining sides and extending laterally outward from a center of the filament. Three of the six apexes are major apexes and three of the six apexes are minor apexes and, the apexes define major and minor lobes. The filament also includes three voids extending axially through the filament, each void substantially radially aligned with each of the major apexes. The present disclosure also includes articles made with hexalobal, tri-void filaments of the present disclosure and carpets made with hexalobal, tri-void filaments of the present disclosure.

One exemplary spinneret plate according to the present disclosure, among others, includes a cluster of three orifices grouped around a central point, where each orifice is generally shaped like an arrow pointing away from the central point, with a first and second outer leg joined at a junction to form an arrow head having an angle a, and a central leg extending from the junction of the outer legs towards the central point, where the central leg of each orifice forms and angle β with the central leg of each other orifice. The spinneret plate produces a filament according to the present disclosure that includes a hexalobal cross-section with three voids extending axially through the filament.

One exemplary method for forming a bulked continuous filament having a hexalobal cross section and three voids extending axially through the filament, among others, includes extruding a synthetic polymer through a spinneret plate of the present disclosure to produce the filament.

These embodiments, uses of these embodiments, and other uses, features and advantages of the present disclosure, will become more apparent to those of ordinary skill in the relevant art when the following detailed description of the preferred embodiments is read in conjunction with the appended figures.

### BRIEF DESCRIPTION OF THE DRAWINGS

The disclosure can be better understood with reference to the following drawings. The components in the drawings are not necessarily to scale, emphasis instead being placed upon clearly illustrating the principles of the present disclosure.

FIG. 1 illustrates a cross-sectional view of a hexalobal, tri-void filament of the present disclosure.

FIG. 2A illustrates a face view of the bottom surface of a portion of a spinneret plate illustrating the capillary design for forming the hexalobal filament of the present disclosure. FIG. 2B is a cross-sectional side view of the spinneret plate of FIG. 2A.

FIG. 3 is a digital image of a cross-sectional view of several prior art single void trilobal cross section filaments known as Brilliance® (U.S. Pat. No. 6,939,608).

FIG. 4 is a digital image of a cross-sectional view of several prior art 4-void square hollow filaments (Antron®).

FIG. 5 is a digital image of a cross-sectional view of several hexalobal, tri-void filaments of the present disclosure.

FIG. 6 is a graph showing the comparative soiling performance of the fibers shown in FIG. 3, FIG. 4, and FIG. 6.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, fiber, fabrics, textiles, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmosphere. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions

As used herein, the terms “fiber” and “filament” refer to filamentous material that can be used in fabric and yarn as well as textile fabrication. Although in the art the term “filament” is often used to refer to fibers of extreme or indefinite length and the term “staple” is used to refer to a fiber of relatively short length, unless indicated otherwise in the surrounding text, the terms “fiber” and “filament” are used interchangeably in the present disclosure. One or more fibers can be used to produce a fabric or yarn. The yarn can be fully drawn or textured according to methods known in the art.

As used herein the term “yarn” refers to a continuous strand or bundle of fibers. Yarn is often used to make articles, such as carpets.

As used herein “glitter” is the property of the yarn relating to the yarn's ability to reflect incident light. The amount of glitter exhibited by a yarn is a measure of the relative fraction of light that is reflected by the yarn. Glitter is also sometimes referred to as “luster”.

As used herein “bulk” is the property of the yarn that most closely correlates to surface coverage ability of a given yarn.

As used herein, the terms “article” or “articles” includes, but are not limited to, fibers, yarns, films, carpets, apparel, furniture coverings, drapes, automotive seat covers, fishing nets, awnings, sail cloth, polyester tie-cord, hoist PET, military apparel, conveying belts, mining belts, water draining cloth, tarps (e.g., truck tarps), seat belts, harnesses, and the like. In particular, the article can be claimed as any one or combination of the articles noted above. In exemplary embodiments of the present disclosure, the article is carpet.

As used herein, the term “carpet” may refer to a structure including a primary backing having a yarn tufted through the primary backing. The underside of the primary backing can include one or more layers of material (e.g., coating layer, a secondary backing, and the like) to cover the backstitches of the yarn. In addition, the term “carpet” can include woven carpets without backing. In exemplary embodiments, the yarn used to form the carpet is made of bulked continuous filaments (BCFs), such as those of the present disclosure. Methods for making BCF yarns for carpets typically include the steps of twisting, heat-setting, tufting, dyeing and finishing.

### General Discussion

Embodiments of the present disclosure are directed to thermoplastic synthetic polymer bulked continuous filaments (BCFs) having a hexalobal cross section and three voids extending through the filament. Embodiments of the hexalobal, three-void filament of the present disclosure provide excellent soil resistance and exhibits a desirable low-glitter appearance. The present disclosure also includes yarn formed from a plurality of such filaments that is easily bulked and, due to its low glitter and lack of soil accumulating surfaces, is believed to be especially useful as carpet yarn. The present disclosure is also directed to articles, including, but not limited to, carpets, made from such yarns. Furthermore, the present disclosure also includes spinneret plates having a capillary design for producing the filament of the present disclosure.

Carpets made from polymer yarns, and particularly polyamide yarns such as nylon, are popular floor coverings for residential and commercial applications. Such carpets are relatively inexpensive and have a desirable combination of qualities, such as durability, aesthetics, comfort, safety, warmth, and quietness. Further, such carpets are available in a wide variety of colors, patterns, and textures. In particular, carpets have various levels of “glitter,” and the amount of glitter desired depends on the use of the carpet. Often, a low-glitter look is preferred when trying to achieve a more natural appearance, and low glitter fibers more closely resemble natural fibers such as wool and cotton. Additionally, carpets made from polymer yarns have other properties, such as soil/stain resistance, bulk, and durability.

Currently the commercial segment commonly uses a 4-void square hollow cross section filament for Antron® carpet and uses a single void hollow cross section for Brilliance®. The single void cross section has a nice subdued luster but performs relatively inferior to the 4-void square hollow cross section in soil resistance. The square hollow filament has good soiling performance but also has a glittery luster. Additionally, the capillary design of the 4-void square hollow filament is weak and needs frequent costly repair. The hexalobal cross section, three-void filament of the present disclosure provides excellent soiling performance and subdued glitter, and the corresponding capillary design is durable and efficient.

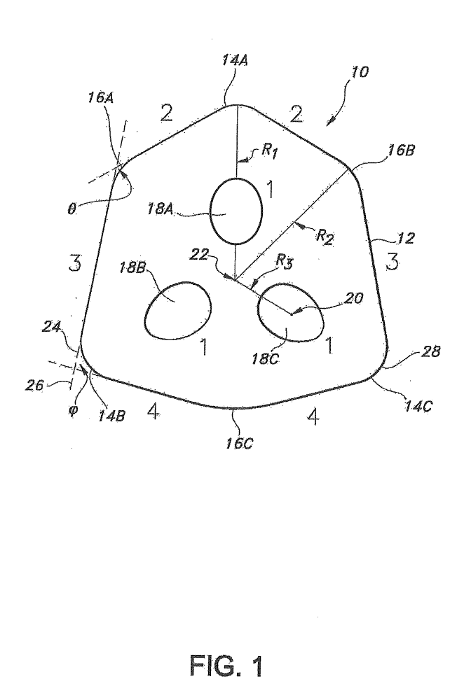

As illustrated in FIG. 1, a bulked continuous filament 10 of the present disclosure has a hexalobal cross-sectional geometry with three major lobes 14 (14A, 14B, and 14C) and three minor lobes 16 (16A, 16B, and 16C). Each minor lobe 16 is located between each of two major lobes 14. In an embodiment, each minor lobe 16 can be located at the approximate midpoint between two major lobes 14, as shown in FIG. 1. As can be seen in the figure, the filament 10 also has three voids 18 (18A, 18B, and 18C) extending axially through the filament, and the approximate center of each void 20 is radially aligned with the approximate center 28 of a corresponding major lobe. In an embodiment, the approximate center 20 of each void is located on a line extending radially from the approximate center 22 of the fiber to the approximate center 28 of a major lobe.

The filament 10, can also be described as having an exterior configuration having six sides 12 and six apexes, each apex located at a meeting point between two adjoining sides and extending radially outward from a center 22 of the filament. The filament includes three major apexes defining major lobes 14 and three minor apexes defining minor lobes 16. The three voids 18 are substantially radially aligned with each of the major apexes. Each apex is defined by an angle formed between two lines (24, 26) tangent to each of two adjoining sides 12 of the filament.

As shown in FIG. 1, each apex is defined by an angle between two adjoining sides 12. The angle θ of each minor apex can be greater than the angle φ of each major apex. In embodiments, the angle θ of each minor apex can be greater than about 90 degrees and the angle φ of each major apex can be less than about 90 degrees. In embodiments, the angle θ of each minor apex can be from about 120 to about 180 degrees and the angle φ of each major apex can be from about 60 to about 120 degrees. In an exemplary embodiment, the angle θ of at least one minor apex can be about 160 degrees and the angle φ of at least one major apex can be about 70 degrees. In some embodiments the angle θ of each minor apex could be about the same, but in other embodiments the angle θ of each minor apex may be slightly different. Likewise, in some embodiments the angle φ of each major apex can be about the same, but in other embodiments the angle φ of each major apex may be slightly different; however, each angle θ of each minor apex may be greater than each angle φ of each major apex.

FIG. 1 also illustrates that the filament of the present disclosure has a radius R1 extending from the approximate center of the filament to an outside edge of the filament at the approximate midpoint of a major lobe, a radius R2 extending from the approximate center of the filament to an outside edge of the filament at the approximate midpoint of a minor lobe, and a radius R3 extending from the approximate center of the filament to the approximate center of a void, where R1>R2>R3. In embodiments R1 can be from about 5 micrometer to about 100 micrometer, R2 can be from about 3 micrometer to about 100 micrometer, and R3 can be from about 2 micrometer to about 60 micrometer.

The void ratio of a BCF can be important in determining the soiling performance of the filament and articles made from the filament. The filament of the present disclosure preferably can have a void ratio of about 2 to about 30% of cross-sectional area of the filament. In an exemplary embodiment the void ratio of the filament can be about 13.5% of the cross-sectional area of the filament.

A filament in accordance with the present disclosure is a bulked continuous filament prepared using a synthetic, thermoplastic melt-spinnable polymer. Suitable polymers include polyamides, polyesters, and polyolefins. In an exemplary method of forming filaments according to the present disclosure, the polymer is first melted and then is extruded (“spun”) through a spinneret plate having appropriately sized orifices therein (to be described hereinafter), under conditions which vary depending upon the individual polymer, to produce a filament 10 having the desired denier, exterior modification ratio, tip ratio, apex ratio and void percentage. In embodiments, the filaments are subsequently quenched by air flowing across them at a flow rate of about 1.2−1.8 ft/sec (about 0.36 to 0.55 m/sec). The void percentage can be increased by more rapid quenching and/or increasing the melt viscosity of thermoplastic melt polymers, which can slow the flow allowing sturdy pronounced molding to occur.

After being spun the fibers of the present disclosure may then be treated with a finish comprising a lubricating oil or mixture of oils and antistatic agents. A plurality of filaments 10 are gathered together to form a yarn, and the yarn bundle can then be wound on a suitable package. Drawing and bulking of the combined filaments is performed by any method known in the art, with the preferred operating condition described below in the examples provided. The yarn is then used to make articles, such as carpet, by methods known to those of skill in the art. An exemplary method of making carpet from yarn formed from filaments of the present disclosure is described in the examples below.

In exemplary embodiments, the yarn is drawn and texturized to form a BCF yarn suitable for tufting into carpets. One technique involves combining the extruded or as-spun fibers into a yarn, then drawing, texturizing and winding into a package all in a single step. This one-step method of making BCF yarn is generally known in the art as spin-draw-texturing (SDT).

In some embodiments, nylon fibers for the purpose of carpet manufacturing have linear densities in the range of about 3 to 75 denier/filament (dpf (denier=weight in grams of a single fiber with a length of 9000 meters). A more preferred range for carpet fibers is from about 6 to 25 dpf.

The BCF yarns can go through various processing steps well known to those skilled in the art. For example, to produce carpets for floor covering applications, the BCF yarns are generally tufted into a pliable primary backing. Primary backing materials are generally selected from woven jute, woven polypropylene, cellulosic nonwovens, and nonwovens of nylon, polyester and polypropylene. The primary backing can then be coated with a suitable latex material such as a conventional styrene-butadiene (SB) latex, vinylidene chloride polymer, or vinyl chloride-vinylidene chloride copolymers. It is common practice to use fillers such as calcium carbonate to reduce latex costs. The final step is typically to apply a secondary backing, generally a woven jute or woven synthetic such as polypropylene. In embodiments, carpets for floor covering applications may include a woven polypropylene primary backing, a conventional SB latex formulation, and either a woven jute or woven polypropylene secondary carpet backing. The SB latex can include calcium carbonate filler and/or one or more of the hydrate materials listed above.

While the discussion above has emphasized the fibers of this disclosure being formed into bulked continuous fibers for purposes of making carpet fibers, the fibers of the present disclosure can be processed to form fibers for a variety of textile applications. In this regard, the fibers can be crimped or otherwise texturized and then chopped to form random lengths of staple fibers having individual fiber lengths varying from about 1½ to about 8 inches.

The fibers of the present disclosure can be dyed or colored utilizing conventional fiber-coloring techniques known to those of skill in the art. For example, the fibers of this disclosure may be subjected to an acid dye bath to achieve desired fiber coloration. Alternatively, the nylon sheath may be colored in the melt prior to fiber-formation (e.g., solution dyed) using conventional pigments for such purpose.

As discussed above, fibers of various cross-sections are formed by melt-spinning fiber-forming polymers through specially designed spinnerets. Spinneret plates used to make fibers have specially designed orifices through which the polymers are melt-spun to produce the fibers. Often, the orifices, or a specific cluster of orifices, used to produce a single fiber is called a capillary. Thus, spinnerets with specifically designed capillaries are used to produce corresponding fibers of a desired cross-sectional geometry.

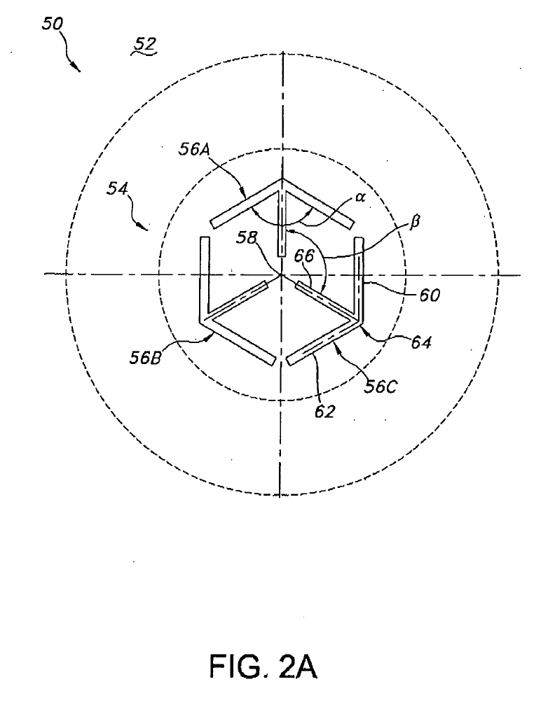

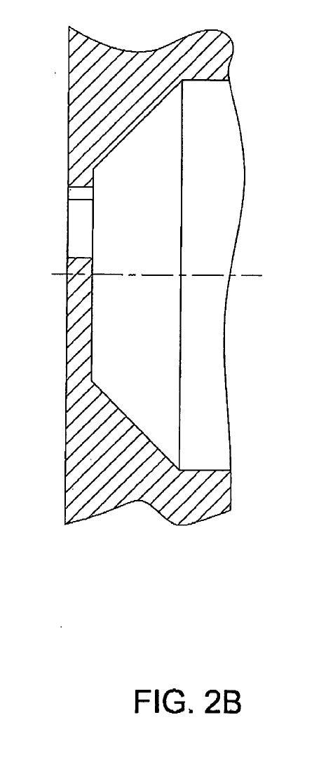

FIG. 2A illustrates a spinneret plate 50 useful for producing a filament 10 in accordance with the present disclosure. The spinneret plate 50 is a relatively massive member having an upper surface (not shown) and a bottom surface 52. As is well appreciated by those skilled in the art a portion of the upper surface of the spinneret plate is provided with a bore recess (not shown) whereby the plate 50 is connected to a source of polymer. Depending upon the rheology of the polymer being extruded the lower margins of the bore recess may be inclined to facilitate flow of polymer from the supply to the spinneret plate.

A plurality of capillary openings each generally indicated by the reference character 54 extends through the plate 50 from the recessed upper surface to the bottom surface 52. Each capillary opening 54 serves to form one filament. Only one such capillary opening 54 is illustrated in FIG. 2A. The number of capillary openings provided in a given plate thus corresponds to the number of filaments being gathered to form a predetermined number of yarn(s). As noted, additional filaments (if used) may be incorporated into the yarn in any convenient manner.

As best seen in FIG. 2A, in the spinneret plate of the present disclosure each capillary opening 54 is itself defined by a cluster of three orifices 56A, 56B, and 56C centered symmetrically about a central point 58. The spinneret plate may be fabricated in any appropriate manner, as by using the laser technique disclosed in U.S. Pat. No. 5,168,143, (Kobsa et al., QP-4171-A), assigned to the assignee of the present disclosure.

The spinneret plate 50 of the present disclosure is designed to producing the filament of the present disclosure with a hexalobal cross-section and three axial voids. The capillary design of the spinneret plate 50 includes a cluster of three orifices 56 (56A, 56B, and 56C) grouped around a central point 58, where each orifice 56 is generally shaped like an arrow pointing away from the central point 58. Each orifice 56 includes a first and second outer leg (60, 62) joined at a junction 64 to form an arrow head having an angle α. The orifice 56 also includes a central leg 66 extending from the junction of the outer legs 64 towards the central point 5. The length of each outer leg can be from about 0.02 centimeter to 0.2 centimeter, and in an exemplary embodiment is about 0.077 centimeter. The length of each center leg can be from about 0.019 to about 0.199 centimeter, and in an exemplary embodiment is about 0.071 centimeter. The width of each outer leg can be from about 0.002 to 0.02 centimeter, and in an exemplary embodiment is about 0.0089 centimeter. The width of each center leg can be from about 0.0015 to 0.019 centimeter, and in an exemplary embodiment is about 0.0064 centimeter.

Each central leg 66 of each orifice forms and angle β with the central leg of each other orifice. In some embodiments of the present disclosure, each angle α can be from about 100 to 140 degrees, and in an exemplary embodiment, each angle α is about 120 degrees. Also, in embodiments of the present disclosure, each angle β is from about 100 to 140 degrees. In an exemplary embodiment, angle β is about 120 degrees.

The various above-defined features of the capillary that open onto the bottom surface 52 of the spinneret plate 50 are defined by parallel surfaces that extend from the bottom surface 52 for at least a portion of the way through the thickness of the plate. This distance is usually termed in the art as the “cap depth”, shown as “E” in FIG. 2B. The parallel surfaces are spaced from each other by a dimension known in the art as the “slot width”. In the production of a polyamide filament the surfaces defining the apertures of the capillary extend in parallel relationship completely through the thickness of the plate 50. For filaments made of other materials, such as polypropylene, it sometimes preferred (for considerations relating to the spinning process) that the parallel surfaces extend over only a predetermined portion of the thickness of the plate, this portion forming a recess in the spinneret plate. Over the remaining portion of this thickness of the plate the surfaces defining the apertures incline outwardly from the axis of the aperture at an angle of inclination on the order of about 45 degrees, though this angle may vary from about 30 to 60 degrees. The diameter of the portion of the recess of the capillary (also known as “slot”) that is parallel to the bottom surface 52 of the plate is shown as “F” in FIG. 2B, and the diameter of the overall slot (including both the parallel portion of the slot and the tapered portion of the slot) is shown as G in FIG. 2B. In embodiments of the disclosure, F is about 0.229 centimeter, but in other embodiments can be from about 0.023 to about 1.22 centimeter. The dimensions of G can be from about 0.03 to about 2.8 centimeter, and in an exemplary embodiment G is about 0.28 centimeter. The overall dimension of the slot (perpendicular to the bottom surface 20B) is usually referred to in the art as the “slot depth”. The slot depth is the parallel portion of the slot. In embodiments of the spinneret plate of the present disclosure the slot depth of the capillary can be from about 0.007 to about 0.38 centimeter.

The capillary design of the spinneret plate of the present disclosure is very durable and easy to spin. This reduces costly repairs and loss of time due to capillary malfunction.

The present disclosure also provides methods of making the hexalobal, tri-void filament of the present disclosure by spinning the fibers using the spinneret plate of the present disclosure having the above-described capillary design.

Additional detailed description of some exemplary embodiments of the BCF of the present disclosure and articles made with the filament of the present disclosure are described in the Example below. However, the specific examples below are to be construed as merely illustrative, and not limitative of the remainder of the disclosure in any way whatsoever. Without further elaboration, it is believed that one skilled in the art can, based on the description herein, utilize the present disclosure to its fullest extent.

### EXAMPLE

For the present example, loop pile carpets were produced using the hexalobal, tri-void BCF fibers of the present disclosure. They had an attractive subdued luster. Carpet samples of the present disclosure, single void Brilliance® and Antron® 4 hole square hollow filament were prepared and described below and tested for soiling performance.

### Sample Preparation

Carpet samples were produced according to the following specifications. 1245 denier, 64 filaments BCF test yarns were produced on a T-60 prototype at 76 pph using a 72 RV, medium acid dyeable polymer containing 0.3% TiO₂, as described below. The test items were produced at 190 C draw roll and 225 bulk jet air temperature. The polymer was extruded through the spinnerets and divided into two (2) sixty-four filament (64) segments. The molten fibers were then rapidly quenched in a chimney, where cooling air at about nine degrees Centigrade (˜10° C.) was blown past the filaments at three hundred and fifty cubic feet per minute [9.9 cubic meters per minute] through the quench zone. The filaments were then coated with a lubricant for drawing and crimping. The coated yarns were drawn at 2380 yards per minute (2.6×draw ratio) using a pair of heated draw rolls. The draw roll temperature was one hundred ninety degrees Centigrade (190° C.). The filaments were then forwarded into a dual-impingement hot air bulking jet, similar to that described in Coon, U.S. Pat. No. 3,525,134, to form two 1245 denier, 19.4 denier per filament (dpf) bulked continuous filament (BCF) yarns. The temperature of the air in the bulking jet was 225 degrees Centigrade (° C.).

The test items included 2 comparative controls and a carpet sample made with the fibers of the present disclosure. The test items are listed below, along with the comparative void ratios.

Item 1 (Comparative control): Brilliance® cross section, void ratio 4.3%

Item 2 (Comparative control): Antron® 4 void square, void ratio 17.5%

Item 3 (hexalobe, tri-void of present disclosure): void ratio 13.5%

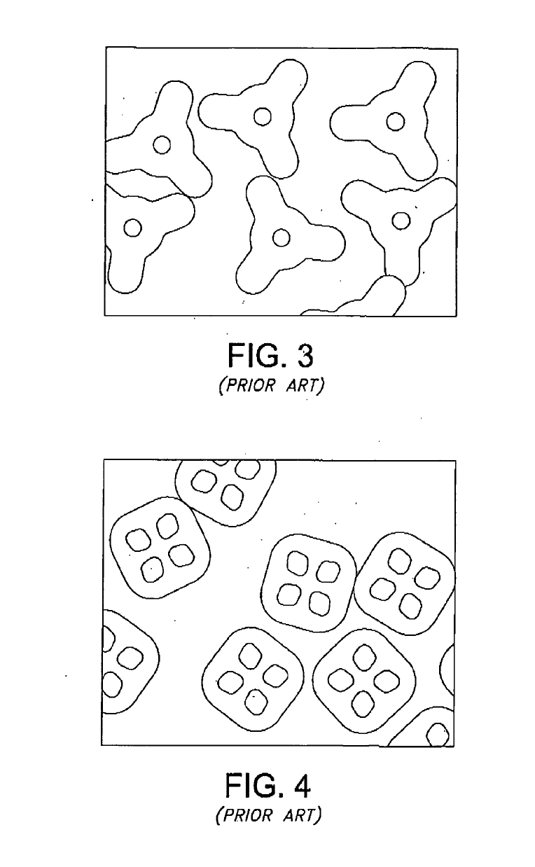

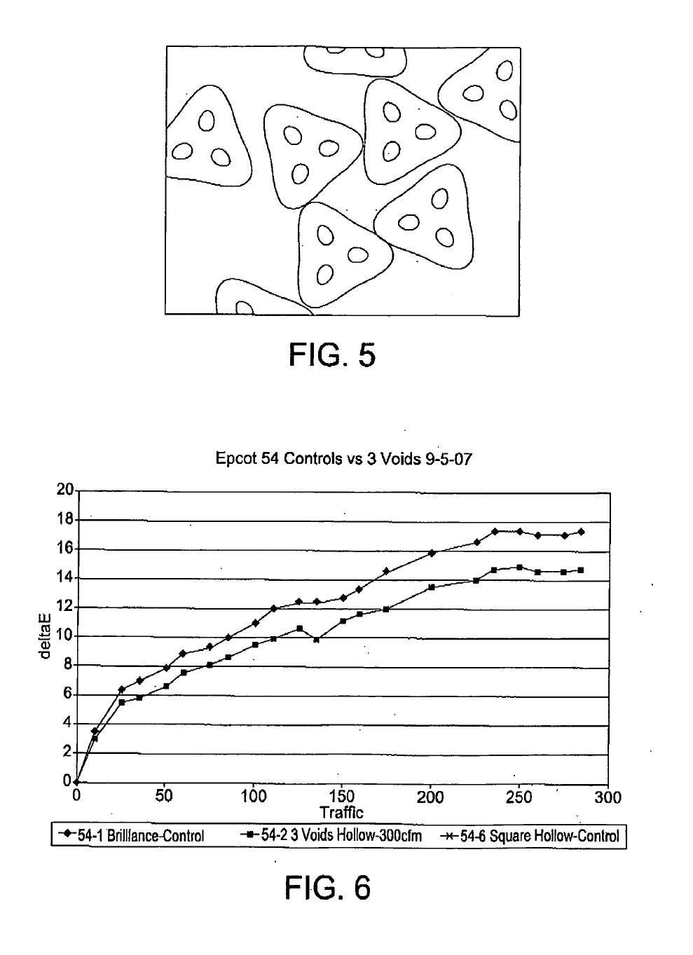

It can be seen that the fibers of the present disclosure have a void ratio closer to the void ratio of comparative item 2, which helps improve soiling performance. Digital images of the cross sections of the fibers of each of the test items are shown in the figures: FIG. 3 (test item 1: Brilliance®); FIG. 4 (test item 2: Antron®); FIG. 5 (test item 3: fiber of the present disclosure).

The spun, drawn, and crimped bulked continuous filament (BCF) yarns were cable-twisted to 3.75 turns per inch (tpi) on a cable twister and heat-set on a Superba heat-setting machine at setting temperature of two hundred sixty five degrees Fahrenheit (265° F.; 129.4° C.). The yarns were then tufted into 36 ounce per square yard, 5/16 inch pile height loop pile carpets on a 1/10 inch gauge (0.254 cm) loop pile tufting machine. The carpets were dyed on a continuous range dyer to light wheat color for soiling tests.

### Soiling Test

Competitive soiling tests were conducted for all of the carpet samples, and the results are shown in FIG. 6 below. Soiling tests were conducted via human traffic in a park. The traffic cycles were about 20,000 to 30,000 cycles per day. The color of the test carpets were recorded at every 10,000 to 20,000 traffic cycles using a hand held color measurement instrument sold by Minolta Corporation as “Chromameter” model CR-210. The color of new and soiled samples were measured using L, A, B color space. The relative soiling performances of the carpets were judged by the color change (Delta E) of soiled carpet versus new carpet at various test cycles. Carpets with high delta E were judged to be poorer performers than carpets with low delta E. After 300,000 cycles, the carpets were removed and the color changes were plotted versus traffic cycles (FIG. 6). After 300 M traffic cycles, the carpet made with the hexalobal, tri-void fibers of the present disclosure showed a significantly better soiling performance than Brilliance® control and performed at least as well in soiling performance as the Antron® control.

These results demonstrate that the hexalobal, tri-void fibers of the present disclosure have the advantage of performing significantly better than Brilliance® in soiling resistance, as well as having the attractive low-luster look preferred by many users over the glittery appearance of other fibers with good soiling resistance, such as the Antron® control sample. Not only is the luster quality of the carpet made from fibers of the present disclosure more subdued and more attractive than the Antron® 4-hole hollow filament control, but the spinneret used for making the fibers of the present disclosure is more sturdy and durable than the spinneret used for making the Antron® fibers.

Thus, this demonstrates that the BCF fibers of the present disclosure and the spinneret design used for making the BCF fibers of the present disclosure provide significant advantages over known BCF fibers and their corresponding spinnerets.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’” includes “about ‘x’ to about ‘y’”. The term “consisting essentially of” is defined to include a formulation that includes the inks or dyes specifically mentioned as well as other components (e.g., solvents, salts, buffers, biocides, binders, an aqueous solution) using in an ink formulation, while not including other dyes or inks not specifically mentioned in the formulation.

Many variations and modifications may be made to the above-described embodiments. All such modifications and variations are intended to be included herein within the scope of this disclosure and protected by the following claims.

We claim the following:

1. A bulked continuous filament formed from at least one synthetic polymer, the filament having a hexalobal cross-sectional geometry with three major lobes and three minor lobes, each minor lobe located between each of two major lobes, the filament having three voids extending axially through the filament, the approximate center of each void radially aligned with the approximate center of a corresponding major lobe.

2. The bulked continuous filament of claim 1, wherein the void ratio is from about 2 to about 30% of the cross-sectional area of the filament.

3. The bulked continuous filament of claim 1, wherein the void ratio is about 8 to 20% of the cross-sectional area of the filament.

4. A bulked continuous filament formed from at least one synthetic polymer,
the filament having a hexalobal cross section and an exterior configuration having six sides and six apexes, each apex located at a meeting point between two adjoining sides and extending laterally outward from a center of the filament, wherein three of the six apexes are major apexes and three of the six apexes are minor apexes and wherein the apexes define major and minor lobes,
the filament also having three voids extending axially through the filament, each void substantially radially aligned with each of the major apexes.

5. The bulked continuous filament of claim 4, wherein each apex is defined by an angle between two adjoining sides, wherein the angle θ of each minor apex is greater than the angle φ of each major apex.

6. The bulked continuous filament of claim 4, wherein the angle θ of each minor apex is 120 to 180 degrees and the angle φ of each major apex is 60 to 120 degrees.

7. The bulked continuous filament of claim 4, wherein the void ratio is from about 2 to about 30% of cross-sectional area of the filament.

8. The bulked continuous filament of claim 4, wherein the void ratio is about 8 to 20% of the cross-sectional area of the filament.

9. The bulked continuous filament of claim 4, wherein the filament has a radius R1 extending from the approximate center of the filament to an outside edge of the filament at the approximate midpoint of a major lobe, a radius R2 extending from the approximate center of the filament to an outside edge of the filament at the approximate midpoint of a minor lobe, and a radius R3 extending from the approximate center of the filament to the approximate center of a void, wherein R1>R2>R3.

10. An article produced with the filament of claim 1 or 4.

11. A carpet produced with the filament of claim 1 or 4.

12. A spinneret plate for producing a bulked continuous filament comprising:
a cluster of three orifices grouped around a central point, wherein each orifice is generally shaped like an arrow pointing away from the central point, with a first and second outer leg joined at a junction to form an arrow head having an angle α, and a central leg extending from the junction of the outer legs towards the central point, wherein the central leg of each orifice forms and angle β with the central leg of each other orifice,
wherein the filament comprises a hexalobal cross-section with three voids extending axially through the filament.

13. The spinneret plate of claim 12, wherein the angle α is from about 100 to about 140 degrees.

14. The spinneret plate of claim 12, wherein the angle α is about 120 degrees.

15. The spinneret plate of claim 12, wherein the angle β is from about 100 to about 140 degrees.

16. The spinneret plate of claim 12, wherein the angle β is about 120 degrees.

17. The spinneret plate of claim 12, wherein the length of each outer leg is from about 0.02 to about 0.20 centimeter.

18. The spinneret plate of claim 12, wherein the length of each center leg is from about 0.019 to about 0.119 centimeter.

19. The spinneret plate of claim 12, wherein the width of each outer leg is from about 0.002 to about 0.020 centimeter.

20. The spinneret plate of claim 12, wherein the width of each center leg is from about 0.0015 to about 0.019 centimeter.

21. A method of forming a bulked continuous filament having a hexalobal cross section and three voids extending axially through the filament, comprising:
extruding a synthetic polymer through the spinneret plate of claim 12 to produce the filament.
